(19) United States
(12) Patent Application Publication
(10) Pub. No.: US 2007/0224339 A1
(43) Pub. Date: Sep. 27, 2007

(54) Method of manufacturing patterned media

(75) Inventors: Yoshiyuki Kamata, Tokyo (JP); Masatoshi Sakurai, Tokyo (JP); Akira Kikitsu, Yokohama-shi (JP); Satoshi Shirotori, Fuchu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/723,845

(22) Filed: Mar. 22, 2007

(30) Foreign Application Priority Data
Mar. 24, 2006 (JP) 2006-084095

(51) Int. Cl. B05D 5/12

(52) U.S. Cl. 427/130

(57) ABSTRACT

According to one embodiment, there is provided a method of manufacturing a patterned media having a substrate and a magnetic recording layer on the substrate including protruded magnetic patterns and a nonmagnetic material filling recesses between the magnetic patterns. The method includes depositing a first nonmagnetic material to fill the recesses between the magnetic patterns, carrying out surface reforming of the first nonmagnetic material, depositing a second nonmagnetic material on the first nonmagnetic material, and etching back the second and first nonmagnetic materials.

### CROSS-REFERENCE TO RELATED APPLICATIONS

This application is based upon and claims the benefit of priority from Japanese Patent Application No. 2006-084095, filed Mar. 24, 2006, the entire contents of which are incorporated herein by reference.

### BACKGROUND

1. Field

One embodiment of the present invention relates to a method of manufacturing a patterned media, more specifically to a method of manufacturing a patterned media having favorable surface flatness.

2. Description of the Related Art

In recent years, magnetic recording media installed in hard disk drives (HDD) are obviously confronted with a problem that improvement in track density is restricted because of interference between adjacent tracks. In particular, to reduce a fringing effect of magnetic fields from a magnetic head has become an important technical problem.

With respect to such a problem, a discrete track recording type patterned media (DTR media), in which recording tracks are physically separated, has been proposed. In the DTR media, because a side-erase phenomenon that information on adjacent tracks is erased at the time of recording and a side-read phenomenon that information on adjacent tracks is read out at the time of reproducing can be reduced, it is possible to increase the track density. Accordingly, the DTR media have been expected as magnetic recording media which can provide a high recording density.

In order to read from and write to the DTR media with a flying head, it is preferred to make the surface of the DTR media flat. Here, in order to completely separate adjacent tracks with each other, about 4 nm-thick protective layer and about 20 nm-thick ferromagnetic recording layer, for example, are removed to form magnetic patterns separated by grooves of about 24 nm in depth. On the other hand, because a designed flying height of the flying head is about 10 nm, if deep grooves are present, flying characteristics of the head are made unstable. Therefore, the surface of the media is flattened by filling the grooves between the magnetic patterns with a nonmagnetic material to ensure the flying stability of the head.

Conventionally, in order to obtain a DTR media having a flat surface by filling the grooves between the magnetic patterns with a nonmagnetic material, the following methods have been proposed. For example, a method has been known that the grooves between the magnetic patterns are filled with a nonmagnetic material by two-stage bias sputtering to manufacture a DTR media with a flat surface (see JP-B 3,686,067). Further, a method has also been known that the grooves between the magnetic patterns are filled with SiO₂ by bias sputtering and then SiO₂ is etched back to manufacture a DTR media with a flat surface (see IEEE Trans. Magn., Vol. 40, No. 4, 2510 (2004)).

However, as a result of studies by the inventors, it has been found that, when the grooves between the magnetic patterns are filled with a nonmagnetic material by means of bias sputtering, the ferromagnetic recording layer is altered and degraded by temperature rise due to substrate bias. Further, because dust is produced in the bias sputtering process and adheres to the media surface, a head crash is easily brought about.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a plan view of a DTR media according to an embodiment;

FIGS. 2A, 2B, 2C, 2D, 2E, 2F, 2G, 2H, 2I and 2J are cross-sectional views showing a method of manufacturing a DTR media according to the embodiment;

FIG. 3A is a cross-sectional view for describing a deposition process for a first nonmagnetic material by high-pressure sputtering;

FIG. 3B is a cross-sectional view for describing a deposition process for a first nonmagnetic material by low-pressure sputtering;

FIG. 4A is a cross-sectional view showing the surface of the first nonmagnetic material deposited by high-pressure sputtering;

FIG. 4B is a cross-sectional view for describing a surface reforming process for the first nonmagnetic material; and

FIG. 5 is a cross-sectional view for describing a deposition process for a second nonmagnetic material.

### DETAILED DESCRIPTION

Various embodiments according to the invention will be described hereinafter with reference to the accompanying drawings. In general, according to one embodiment of the present invention, there is provided a method of manufacturing a patterned media comprising a substrate and a magnetic recording layer on the substrate including protruded magnetic patterns and a nonmagnetic material filling recesses between the magnetic patterns, the method comprising: depositing a first nonmagnetic material to fill the recesses between the magnetic patterns; carrying out surface reforming of the first nonmagnetic material; depositing a second nonmagnetic material on the first nonmagnetic material; and etching back the second and first nonmagnetic materials.

Hereinafter, embodiments of the present invention will be described with reference to the drawings.

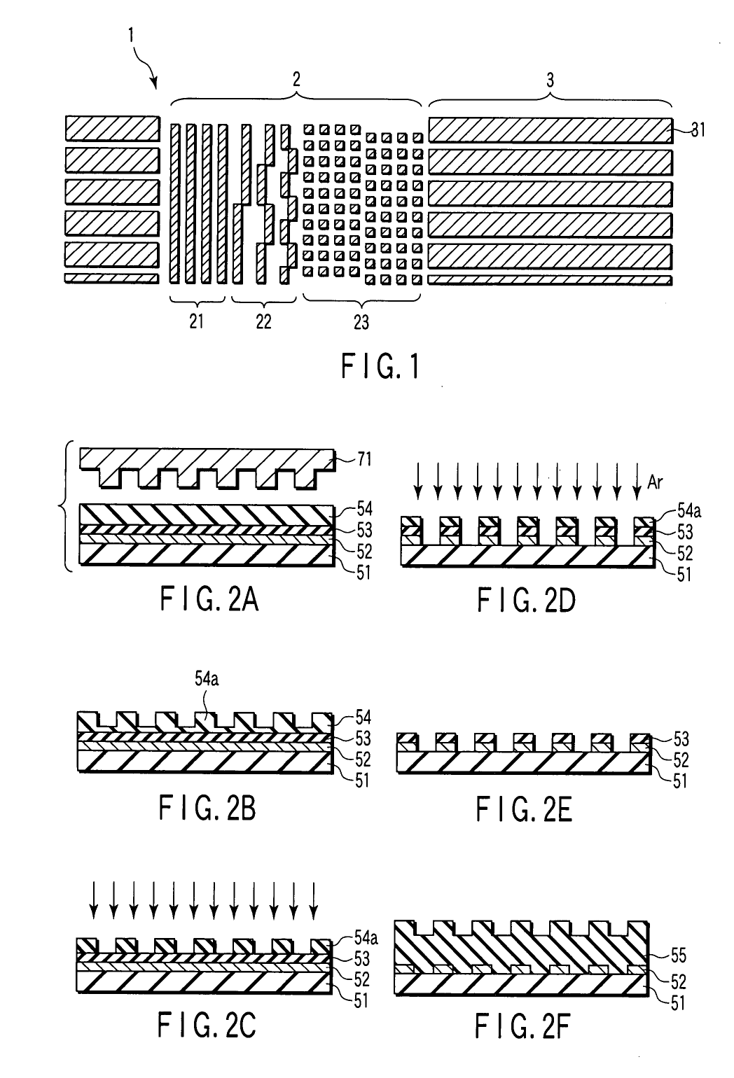

FIG. 1 shows a plan view in a circumferential direction of a DTR media according to an embodiment of the present invention. As shown in FIG. 1, servo areas 2 and data areas 3 are alternately formed in the circumferential direction of the DTR media 1. The servo area 2 includes a preamble part 21, an address part 22, and a burst part 23. The data area 3 includes discrete tracks 31.

In brief, the DTR media according to the embodiment can be manufactured through the processes of depositing a ferromagnetic recording layer, processing the ferromagnetic recording layer by imprint lithography, and filling a nonmagnetic material and processing thereof. In imprint lithography, a stamper is used which has patterns of protrusions and recesses, reversed to the patterns of protrusions and recesses on the DTR media shown in FIG. 1.

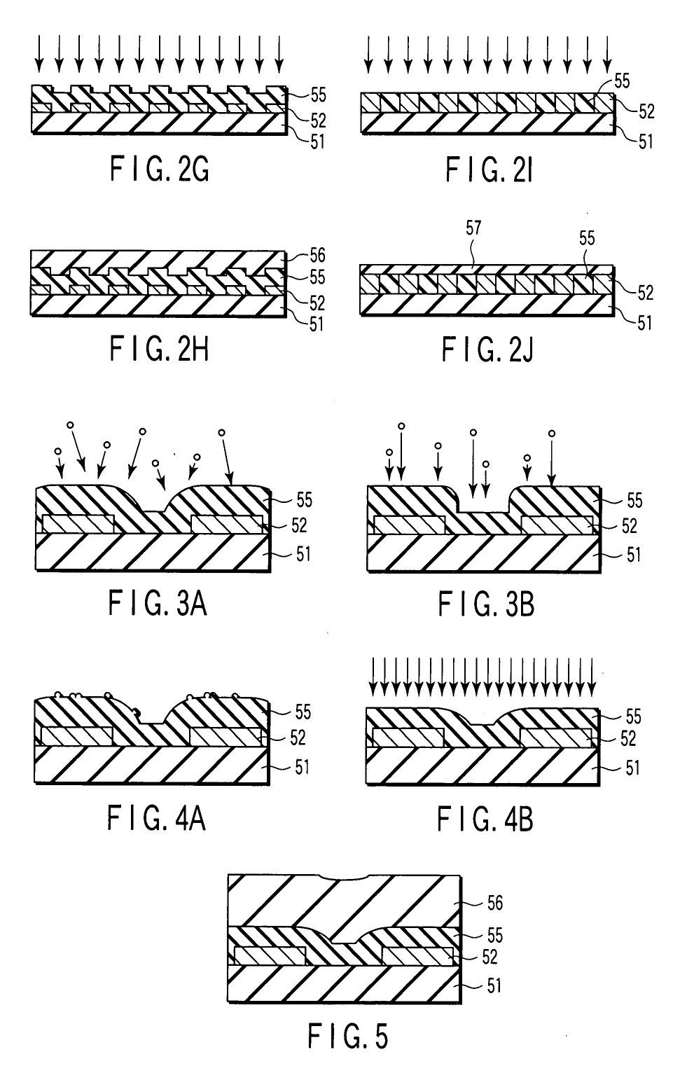

A method of manufacturing a DTR media according to the embodiment will be described with reference to FIGS. 2A, 2B, 2C, 2D, 2E, 2F, 2G, 2H, 2I, and 2J, and FIGS. 3A, 3B, 4A, 4B, and 5.

A soft underlayer formed of 120 nm-thick CoZrNb, an orientation control layer formed of 20 nm-thick Ru, a ferromagnetic recording layer 52 formed of 20 nm-thick CoCrPt—SiO₂, and a protective layer 53 formed of 4 nm-thick carbon (C) are sequentially deposited on a glass substrate 51. Here, for simplicity, the soft underlayer and the orientation control layer are not depicted. The protective layer 53 is spin-coated with 100 nm-thick spin-on-glass (SOG) as a resist 54. A stamper 71 is disposed so as to face the resist 54. Patterns of protrusions and recesses reversed to the magnetic patterns shown in FIG. 1 are formed on the stamper 71 (FIG. 2A).

Imprinting is carried out by using the stamper 71, thereby protrusions 54a of the resist 54 are formed corresponding to the recesses of the stamper 71 (FIG. 2B).

Etching is carried out with an inductively-coupled plasma (ICP) etching apparatus to remove resist residues remaining on the bottoms of the recesses of the patterned resist 54. The conditions in this process are, for example, as follows: CF₄ is used as a process gas, a chamber pressure is set to 2 mTorr, RF powers for the coil and platen are set to 100 W, respectively, and an etching time is set to 30 seconds (FIG. 2C).

Ion milling is carried out with an electron cyclotron resonance (ECR) ion gun using the remaining resist patterns (SOG) as etching-resistive masks to etch the 4 nm-thick protective layer 53 and the nm-thick ferromagnetic layer 52 (FIG. 2D). The conditions in this process are, for example, as follows: Ar is used as a process gas, a microwave power is set to 800 W, an accelerating voltage is set to 500V, and an etching time is set to 3 minutes.

Thereafter, the resist patterns (SOG) are stripped with an RIE apparatus (FIG. 2E). The conditions in this process are, for example, as follows: CF₄ gas is used as a process gas, a chamber pressure is set to 100 mTorr, and a power is set to 100 W.

Next, carbon (C) is deposited as a first nonmagnetic material 55 with a sputtering apparatus for HDD by high-pressure sputtering without applying a substrate bias (FIG. 2F) so as to fill the recesses between the magnetic patterns. The conditions in this process are, for example, as follows: an Ar pressure is set to a high pressure of between 1 and 10 Pa, for example, 7 Pa, a substrate bias is not applied, and a power is set to, for example, 500 W. The thickness of the carbon, the first nonmagnetic material 55, is preferably in a range of 30 nm to 100 nm. If the thickness of the carbon is less than 30 nm, the ferromagnetic recording layer may be damaged in the following process, which is unfavorable.

An effect of the high-pressure sputtering at this process will be described with reference to FIGS. 3A and 3B. As shown in FIG. 3A, when the high-pressure sputtering is used, mean free paths of sputtered particles are made short, and incident directions of the particles are dispersed. Thus, the first nonmagnetic material 55 formed on the side walls of the magnetic patterns 52 has favorable coverage. As a result, although the depths of recesses are not considerably changed, the widths of the recesses are narrowed. On the other hand, as shown in FIG. 3B, when low-pressure sputtering is used in this process, mean free paths of sputtered particles are made long, and the particles are incident on the recesses from the normal direction. Thus, the first nonmagnetic material 55 formed on the side walls of the magnetic patterns 52 has poor coverage.

However, when a high-pressure sputtering is used, surface roughness of the first nonmagnetic material 55 is increased to be 1 to 2 nm as shown in FIG. 4A. Note that the surface roughness of the ferromagnetic recording layer 52 before filling of the first nonmagnetic material 55 is about 0.6 nm.

Next, surface reforming of the first nonmagnetic material 55 is carried out with an ECR ion gun (FIG. 2G). The conditions in this process are, for example, as follows: an Ar pressure is set to 1 to 10 Pa, preferably 3 to 4 Pa, a microwave power is set to 800 W, an accelerating voltage is set to 500V, and Ar ions are applied to the first nonmagnetic material 55 for one minute. Under the conditions, the first nonmagnetic material 55 is etched by about 10 nm. As a result, as shown in FIG. 4B, the surface roughness of the first nonmagnetic material 55 is decreased to be 0.6 nm which is equivalent to that of the ferromagnetic recording layer 52 before processing. In addition, the depths of the recesses on the surface of the first nonmagnetic material 55 are reduced to be about 12 nm. Thus, the surface reforming can reduce the surface roughness as well as the depths of the recesses. Because this process is for the purpose of reforming the surface of the first nonmagnetic material 55, the operating condition of the ECR ion gun such as a process time is not necessary an important parameter. As the ion irradiation time is made longer, the effects of reducing the surface roughness and decreasing the depths of the recesses are increased. However, in order to obtain above effects, it is necessary to make the nonmagnetic material thick in the process of filling the first nonmagnetic material 55 (FIG. 2F).

Note that, the process gas is not limited to Ar, and a mixed gas of Ar and O₂ may be used. When a mixed gas of Ar and O₂ is used, the effect of reducing the surface roughness is inferior, but the effect of decreasing the depths of the recesses is made greater, as compared with a case of using only Ar.

When an Si-based nonmagnetic material, such as SiO₂, SiC and SiN, is used in the process of filling the first nonmagnetic material 55 (FIG. 2), a mixed gas of Ar and a fluorine-containing gas such as CF₄ may be used as the gas for surface reforming. In this case as well, the effect of reducing the surface roughness is inferior, but the effect of decreasing the depths of the recesses is made greater, as compared with a case of using only Ar.

Next, about 10 nm-thick carbon (C), for example, is deposited as a second nonmagnetic material 56 on the first nonmagnetic material 55 by low-pressure sputtering with a sputtering apparatus for HDD without applying substrate bias (FIG. 2H and FIG. 5). The conditions in this process are, for example, as follows: an Ar pressure is set to less than 1 Pa, preferably 0.35 to 0.6 Pa, for example, 0.52 Pa, a substrate bias is not applied, and a power is set to, for example, 500 W. Thus, the second nonmagnetic material 56 is deposited on the first nonmagnetic material 55 whose surface roughness has been decreased by low-pressure sputtering which does not increase the surface roughness. Therefore, the surface roughness of the second nonmagnetic material 56 can be decreased significantly.

On the other hand, the conventional method is equivalent to that the deposition process in FIG. 2F is performed only once to form a thick first nonmagnetic material 55 and the etching-back process in FIG. 2I is performed for the first nonmagnetic material 55 in a state that the surface roughness is great as in FIG. 4A. In this case, the first nonmagnetic material 55 after the etching-back is made in such a state that the great surface roughness is left thereon.

Note that, when the second nonmagnetic material 56 is made thin, this process may be carried out by high-pressure sputtering. Generally, in a case of depositing a thin film, the high-pressure sputtering does not increase significantly the surface roughness thereof. However, if a film thicker than 50 nm is deposited by high-pressure sputtering, the surface roughness thereof is increased. For this reason, the thickness of carbon serving as the second nonmagnetic material 56 is preferably made 50 nm or less. For example, in a case where the depths of the recesses cannot be greatly reduced in the surface reforming process in FIG. 2G, a thick second nonmagnetic material 56 may deposited. However, the thickness of the second nonmagnetic material 56 is preferably made 50 nm or less in order to prevent the surface roughness from being increased.

The second nonmagnetic material may not necessarily be the same as the first nonmagnetic material. For example, SiO₂ may be used as the first nonmagnetic material, and carbon may be used as the second nonmagnetic material. SiO₂ is generally deposited by RF sputtering. However, RF sputtering is likely to make the particle size to be sputtered greater, and is very hard to form a thick film with low surface roughness. Then, the recesses are filled with SiO₂ as the first nonmagnetic material, and the surface roughness thereof is reduced in the surface reforming process, and thereafter, carbon whose surface roughness is not greatly increased is deposited as the second nonmagnetic material, thereby making it possible to decrease the surface roughness.

Usually, as a nonmagnetic material filling the recesses, an oxide is used that does not cause magnetic coupling (exchange coupling or antiferromagnetic coupling) and does not form an alloy with the ferromagnetic recording layer processed into the protruded magnetic patterns. However, because the oxide such as SiO₂ is necessary to be deposited by RF sputtering which is likely to increase process dust, it is difficult to form a thick film with low surface roughness. On the other hand, a metal-based nonmagnetic material is easily formed into a thick film with low surface roughness. In particular, a metal such as Cu, Al, Ag, or Au, which can be reflowed, is easier to be formed into a thick film filling the recesses and having a flat surface. However, when a metal nonmagnetic material is used, alloying or magnetic coupling with the ferromagnetic layer may be brought about. Thus, the metal nonmagnetic material is unsuitable for filling the recesses. To the contrary, in the method according to the embodiment, a material without problems of alloying or magnetic coupling, such as carbon and SiO₂, is used as a first nonmagnetic material, and a metal, such as Ti, Ta, W, Pt, Pd, Ru, Rh, Cu, Al, Ag and Au, can be used as a second nonmagnetic material.

Thereafter, ion milling is carried out with an ECR ion gun to etch back the second nonmagnetic material 56 and the first nonmagnetic material 55 (FIG. 2I). The conditions in this process are, for example, as follows: Ar is used as a process gas, a microwave power is set to 800 W, an accelerating voltage is set to 700V, and an etching time is set to 5 minutes. The end-point of the etching-back can be judged by the time when Co included in the ferromagnetic recording layer is detected with Q-MASS (quadrupole mass spectrometer). In the method according to the embodiment, it is impossible to precisely judge how much the first nonmagnetic material 55 is etched at the surface reforming process (FIG. 2G). Therefore, if the etching-back is time-controlled in this process, judgment of the end-point of the etching-back is made inaccurate. Accordingly, in order to make it possible to perform highly-accurate etching-back, the end-point of the etching-back is detected by using the Q-MASS as described above or another detector capable of detecting the end-point of the etching (for example, a secondary ion mass spectrometer: SIMS).

Finally, a protective layer 57 is formed by depositing carbon (C) again by chemical vapor deposition (CVD) (FIG. 2J). Moreover, the protective layer 57 is coated with a lubricant to manufacture a DTR media.

In another embodiment, the surface reforming process (FIG. 3G) and the deposition process for a second nonmagnetic material (FIG. 3H) may be repeated a plurality of times. By repeating these processes a plurality of times, it is possible to further decrease the depth of the recesses and the surface roughness.

Next, suitable materials used in the embodiments of the present invention will be described.

<Substrate>

The substrate may be, for example, a glass substrate, an Al alloy substrate, a ceramic substrate, a carbon substrate, a Si single-crystal substrate having an oxide on the surface thereof. The glass substrate may be formed of amorphous glass or crystallized glass. The amorphous glass includes generally used soda lime glass and aluminosilicate glass. The crystallized glass includes lithium-based crystallized glass. The ceramic substrate includes a sintered body mainly formed of generally used aluminum oxide, aluminum nitride or silicon nitride, or a material obtained by fiber-reinforcing the sintered body. The substrate may be one in which a NiP layer is formed on the surface of the metal substrate or non-metal substrate described above by plating or sputtering.

<Soft Magnetic Under Layer>

The soft underlayer (SUL) is provided so as to pass a recording field from a magnetic head such as a single-pole head to magnetize the perpendicular recording layer therein and to return the recording field to a return yoke arranged near the recording magnetic pole. That is, the soft underlayer provides a part of the function of the write head, serving to apply a steep perpendicular magnetic field to the recording layer so as to improve recording and reproduction efficiency.

The soft underlayer may be made of a material containing at least one of Fe, Ni, and Co. Such materials include an FeCo alloy such as FeCo and FeCoV, an FeNi alloy such as FeNi, FeNiMo, FeNiCr and FeNiSi, an FeAl alloy and FeSi alloy such as FeAl, FeAlSi, FeAlSiCr, FeAlSiTiRu and FeAlO, an FeTa alloy such as FeTa, FeTaC and FeTaN, and an FeZr alloy such as FeZrN.

The soft underlayer may be made of a material having a microcrystalline structure or a granular structure containing fine grains dispersed in a matrix such as FeAlO, FeMgO, FeTaN and FeZrN, each containing 60 at % or more of Fe.

The soft underlayer may be made of other materials such as a Co alloy containing Co and at least one of Zr, Hf, Nb, Ta, Ti and Y. The material preferably contains 80 at % or more of Co. An amorphous layer can be easily formed when the Co alloy is deposited by sputtering. The amorphous soft magnetic material exhibits very excellent soft magnetism because of free from magnetocrystalline anisotropy, crystal defects and grain boundaries. The use of the amorphous soft magnetic material may reduce media noise. Preferred amorphous soft magnetic materials include, for example, a CoZr-, CoZrNb- and CoZrTa-based alloys.

Another underlayer may be provided under the soft underlayer in order to improve the soft underlayer in the crystallinity or in the adhesion to the substrate. Materials for the underlayer include Ti, Ta, W, Cr, Pt, and an alloy thereof, and oxide and nitride containing the above metal. An intermediate layer may be provided between the soft underlayer and the recording layer. The intermediate layer serves to cut off exchange coupling interaction between the soft underlayer and the recording layer and to control the crystallinity of the recording layer. Materials for the intermediate layer include Ru, Pt, Pd, W, Ti, Ta, Cr, Si and an alloy thereof, and oxide and nitride containing the above metal.

To prevent spike noise, the soft underlayer may be divided into layers antiferromagnetically coupled with each other through a Ru layer with a thickness of 0.5 to 1.5 nm sandwiched therebetween. Alternatively, the soft underlayer may be exchange-coupled with a pinning layer made of a hard magnetic layer with in-plane anisotropy such as CoCrPt, SmCo and FePt or an antiferromagnetic layer such as IrMn and PtMn. In this case, to control the exchange coupling force, a magnetic layer such as Co or a nonmagnetic layer such as Pt may be provided on and under the Ru layer.

<Magnetic Recording Layer>

The perpendicular recording layer is preferably made of a material mainly containing Co, containing at least Pt, and further containing an oxide. The perpendicular magnetic recording layer may include Cr as desired. Particularly suitable oxide is silicon oxide and titanium oxide. The perpendicular recording layer preferably has a structure in which magnetic grains, i.e., crystalline grains with magnetism are dispersed in the layer. The magnetic grains preferably have a columnar configuration penetrating the perpendicular recording layer. Such a structure improves orientation and crystallinity of the magnetic grains in the perpendicular recording layer, making it possible to provide a signal-to-noise ratio (SNR) suitable for high-density recording. The amount of oxide is important for obtaining the above structure.

The oxide content to the total amount of Co, Pt and Cr is preferably 3 mol % or more and 12 mol % or less, more preferably 5 mol % or more and 10 mol % or less. If the oxide content of the perpendicular recording layer is within the above range, the oxide is precipitated around the magnetic grains, making it possible to isolate the magnetic grains and to reduce their sizes. If the oxide content exceeds the above range, the oxide remains in the magnetic grains to degrade the orientation and crystallinity. Moreover, the oxide is precipitated over and under the magnetic grains to prevent formation of the columnar structure penetrating the perpendicular recording layer. On the other hand, if the oxide content is less than the above range, the isolation of the magnetic grains and the reduction in their sizes are insufficient. This increases media noise in reproduction and makes it impossible to obtain a SNR suitable for high-density recording.

The Cr content of the perpendicular recording layer is preferably 0 at % or more and 16 at % or less, more preferably 10 at % or more and 14 at % or less. When the Cr content is within the above range, high magnetization can be maintained without unduly reduction in the uniaxial magnetic anisotropy constant Ku of the magnetic grains. This brings read/write characteristics suitable for high-density recording and sufficient thermal fluctuation characteristics. If the Cr content exceeds the above range, Ku of the magnetic grains decreases to degrade the thermal fluctuation characteristics as well as to degrade the crystallinity and orientation of the magnetic grains. As a result, the read/write characteristics may be degraded.

The Pt content of the perpendicular recording layer is preferably 10 at % or more and 25 at % or less. When the Pt content is within the above range, the perpendicular recording layer provides a required uniaxial magnetic anisotropy constant Ku. Moreover, the magnetic grains exhibit good cyrstallinity and orientation, resulting in thermal fluctuation characteristics and read/write characteristics suitable for high-density recording. If the Pt content exceeds the above range, a layer of an fcc structure may be formed in the magnetic grains to degrade the crystallinity and orientation. On the other hand, if the Pt content is less than the above range, it is impossible to obtain Ku to provide thermal fluctuation characteristics suitable for high-density recording.

The perpendicular recording layer may contain not only Co, Pt, Cr and an oxide but also one or more additive elements selected from the group consisting of B, Ta, Mo, Cu, Nd, W, Nb, Sm, Tb, Ru and Re. These additive elements enable to facilitate reduction in the sizes of the magnetic grains or to improve the crystallinity and orientation. This in turn makes it possible to provide read/write characteristics and thermal fluctuation characteristics more suitable for high-density recording. These additive elements may preferably be contained totally in 8 at % or less. If the total content exceeds 8 at %, a phase other than the hcp phase is formed in the magnetic grains. This degrades crystallinity and orientation of the magnetic grains, making it impossible to provide read/write characteristics and thermal fluctuation characteristics suitable for high-density recording.

Other materials for the perpendicular recording layer include a CoPt alloy, a CoCr alloy, a CoPtCr alloy, CoPtO, CoPtCrO, CoPtSi and CoPtCrSi. The perpendicular recording layer may be formed of a multilayer film containing a Co film and a film of an alloy mainly including an element selected from the group consisting of Pt, Pd, Rh and Ru. The perpendicular recording layer may be formed of a multilayer film such as CoCr/PtCr, CoB/PdB and CoO/RhO, which are prepared by adding Cr, B or O to each layer of the above multilayer film.

The thickness of the perpendicular recording layer preferably ranges between 5 nm and 60 nm, more preferably between 10 nm and 40 nm. The perpendicular recording layer having a thickness within the above range is suitable for high-density recording. If the thickness of the perpendicular recording layer is less than 5 nm, read output tends to be so low that a noise component becomes relatively high. On the other hand, if the thickness of the perpendicular recording layer exceeds 40 nm, read output tends to be so high as to distort waveforms. The coercivity of the perpendicular recording layer is preferably 237,000 A/m (3,000 Oe) or more. If the coercivity is less than 237,000 A/m (3,000 Oe), the thermal fluctuation tolerance may be degraded. The perpendicular squareness of the perpendicular recording layer is preferably 0.8 or more. If the perpendicular squareness is less than 0.8, the thermal fluctuation tolerance tends to be degraded.

<Protective Layer>

The protective layer serves to prevent corrosion of the perpendicular recording layer and to prevent damage to the media surface when the magnetic head comes into contact with the media. Materials for the protective layer include, for example, C, SiO₂ and ZrO₂. The protective layer preferably has a thickness of 1 to 10 nm. When the thickness of the protective layer is within the above range, the distance between the head and the media can be reduced, which is suitable for high-density recording. Carbon can be classified into sp²-bonded carbon (graphite) and sp³-bonded carbon (diamond). The sp³-bonded carbon is more excellent in durability and anticorrosion but is inferior in surface smoothness to graphite. Normally, carbon is deposited by sputtering using a graphite target. This method forms amorphous carbon in which the sp²-bonded carbon (graphite) and sp³-bonded carbon are mixed. The amorphous carbon containing the sp³-bonded carbon in a high ratio is referred to as diamond-like carbon (DLC). The DLC exhibits excellent durability and anticorrosion and also is excellent in the surface smoothness because it is amorphous. In chemical vapor deposition (CVD), DLC is produced through excitation and decomposition of raw material gases in plasma and reaction of the decomposed species, so that DLC further rich in the sp³-bonded carbon can be produced.

Next, suitable manufacturing conditions in respective processes (except for deposition of the first nonmagnetic material, surface reforming, and deposition of the second nonmagnetic material) according to the embodiments will be described.

<Imprinting>

A resist is applied to the surface of the substrate by spin-coating, and a stamper is pressed against it, thereby transferring the patterns of the stamper onto the resist. The resist includes, for example, a general novolak-based photoresist, or spin-on-glass (SOG). The surface of the stamper on which patterns of protrusions and recesses corresponding to servo information and recording tracks are formed are made to face the resist on the substrate. At this time, the stamper, the substrate, and the buffer layer are laminated on a lower plate of a die set, and those are sandwiched with an upper plate of the die set, and pressed, for example, at 2000 bar for 60 seconds. The heights of the patterns of protrusions formed in the resist by imprinting are, for example, 60 to 70 nm. The resist to be eliminated is moved by holding it for about 60 seconds in this state. Applying a fluorine-containing releasing agent on the stamper enables to favorably release the stamper from the resist.

<Removal of resist Residues>

Residues remaining on the bottoms of the recesses of the resist are removed by reactive ion etching (RIE). In this process, an appropriate process gas is used depending on the resist material. As a plasma source, inductively-coupled plasma (ICP) which can generate high-density plasma at low pressure is suitable. However, electron cyclotron resonance (ECR) plasma, or a general parallel plate type RIE apparatus may be used.

<Ferromagnetic Layer Etching>

After the residues are removed, the ferromagnetic layer is processed by using the resist patterns as etching masks. Etching using an Ar ion beam (Ar ion milling) is suitable for processing the ferromagnetic layer. However, RIE using a Cl gas or a mixed gas of CO and NH₃ may be used. In the case of the RIE using a mixed gas of CO and NH₃, hard masks of Ti, Ta, W, or the like are used as etching masks. In the case of using the RIE, the side walls of the protruded magnetic patterns are hardly tapered. In the case where the ferromagnetic layer is processed by Ar ion milling by which it is possible to etch any material, for example, when the etching is carried out at an accelerating voltage set to 400V while an ion incident angle is being changed from 30° to 70°, the side walls of the protruded magnetic patterns are hardly tapered. In milling with an ECR ion gun, when the etching is carried out in a static type (at an ion incident angle of 90°), the side walls of the protruded magnetic patterns are hardly tapered.

<Resist Stripping>

After the ferromagnetic layer is etched, the resist is stripped. When a general photoresist is used, the resist can be easily stripped by carrying out oxygen plasma processing. Concretely, the photoresist is stripped using an oxygen ashing apparatus, for example, under the following conditions: a chamber pressure is set to 1 Torr, a power is set to 400 W, and a processing time is set to 5 minutes. When SOG is used as the resist, SOG is stripped by RIE using a fluorine gas. As a fluorine gas, CF₄ or SF₆ is suitable. Note that, because there are possibilities that a fluorine gas reacts with water in atmosphere to produce acid such as HF, H₂SO₄, or the like, it is preferable to carry out rinsing.

<Etching-Back of Non-Magnetic Material>

The etching-back is carried out until the ferromagnetic film is exposed. This etching-back process can be carried out by using, for example, Ar ion milling. When a silicon-based nonmagnetic material such as SiO₂ is used, the etching-back may be carried out by RIE using a fluorine-based gas. Further, the etching-back of the nonmagnetic material may be carried out by using an ECR ion gun.

<Protective Layer Formation and Post-Processing>

After the etching-back, a carbon protective layer is formed. The carbon protective layer can be deposited by CVD, sputtering, or vacuum evaporation. By the CVD, a DLC film including a large amount of sp³-bonded carbon is formed. A lubricant is applied to the protective layer. As a lubricant, for example, perfluoro polyether, fluorinated alcohol, or fluorinated carboxylic acid can be used.

### EXAMPLES

### Example 1

A DTR media was manufactured by the method shown in FIGS. 2A to 2J using a stamper having patterns of protrusions and recesses corresponding to servo patterns (preamble, address, and burst) and recording tracks as shown in FIG. 1.

In the deposition process for the first nonmagnetic material 55 (FIG. 2F), 50 nm-thick carbon was deposited under an Ar pressure of as high as 7.0 Pa. In the surface reforming process (FIG. 2G), the first nonmagnetic material 55 was irradiated with Ar ions for one minute using an ECR ion gun under a microwave power of 800 W, and an accelerating voltage of 500V. In the deposition process for the second nonmagnetic material 56 (FIG. 2H), 10 nm-thick carbon was deposited under an Ar pressure of as low as 0.52 Pa. Other processes as described in FIGS. 2I and 2J were performed to manufacture the DTR media.

With respect to the resultant DTR media, a glide test was carried out by using a glide head of a designed flying height of 15 nm to which an acoustic emission (AE) sensor is attached so as to examine contact of the head with the media. As a result, no AE signal was observed. When the surface of the media was observed with an atomic force microscope (AFM), the surface roughness Ra was 0.6 nm and the depths of the recesses were 8 nm. When the glide head was observed with an optical microscope after the measurement, no adhesion of the lubricant to the head slider was observed.

### Comparative Example 1

A DTR media was manufactured by a method in which a deposition process for a nonmagnetic material (carbon) is carried out only once using the same stamper as in Example 1. That is, in the deposition process for the first nonmagnetic material 55 (FIG. 2F), 100 nm-thick carbon was deposited under an Ar pressure of as high as 7.0 Pa, and the carbon was etched back to manufacture the DTR media.

With respect to the resultant DTR media, a glide test was carried out by using a glide head of a designed flying height of 15 nm to which an acoustic emission (AE) sensor is attached so as to examine contact of the head with the media. As a result, no AE signal was observed immediately after starting the measurement. However, a weak AE signal was observed about two hours later. When the glide head was observed with an optical microscope after the measurement, adhesion of the lubricant to the head slider was observed. When the surface of the media was observed with an AFM, the surface roughness Ra was 1.8 nm and the depths of the recesses were 10 nm. Accordingly, it was found that, because the surface roughness Ra of the media was great, flying characteristics of the head were made unstable and the lubricant was gradually adhered to the head.

### Example 2

A DTR media was manufactured by the same processes as those in Example 1 except that the surface reforming process (FIG. 2G) and the deposition process for the second nonmagnetic material (FIG. 2H) were repeated twice. More specifically, the following processes were performed. In the deposition process for the first nonmagnetic material 55 (FIG. 2F), 50 nm-thick carbon was deposited under an Ar pressure of as high as 7.0 Pa. In the surface reforming process (FIG. 2G), the first nonmagnetic material 55 was irradiated with Ar ions for one minute using an ECR ion gun under a microwave power of 800 W, and an accelerating voltage of 500V. In the deposition process for the second nonmagnetic material 56 (FIG. 2H), 10 nm-thick carbon was deposited under an Ar pressure of as low as 0.52 Pa. In the second surface reforming process (FIG. 2G), the second nonmagnetic material 56 was irradiated with Ar ions for one minute using an ECR ion gun under a microwave power of 800 W, and an accelerating voltage of 500V. In the second deposition process for the second nonmagnetic material 56 (FIG. 2H), 10 nm-thick carbon was deposited under an Ar pressure of as low as 0.52 Pa.

With respect to the resultant DTR media, a glide test was carried out by using a glide head of a designed flying height of 15 nm to which an acoustic emission (AE) sensor is attached so as to examine contact of the head with the media. As a result, no AE signal was observed. Moreover, the similar glide test was carried out by using a low-flying head (designed flying height: 13 nm), and no AE signal was observed. When the surface of the media was observed with an AFM, the surface roughness Ra was 0.4 nm, which was equivalent to that of the glass substrate, and the depths of the recesses were 4 nm. When the glide head was observed with an optical microscope after the measurement, no adhesion of the lubricant to the head slider was observed.

### Example 3

A DTR media was manufactured as follows using the same stamper as in Example 1 and using SiO₂ as a first nonmagnetic material.

In the deposition process for the first nonmagnetic material 55 (FIG. 2F), 50 nm-thick SiO₂ was deposited under an Ar pressure of as high as 7.0 Pa. In the surface reforming process (FIG. 2G), the first nonmagnetic material 55 was irradiated with Ar ions for one minute using an ECR ion gun under a microwave power of 800 W, and an accelerating voltage of 500V. In the deposition process for the second nonmagnetic material 56 (FIG. 2H), 10 nm-thick carbon was deposited under an Ar pressure of as low as 0.52 Pa. Other processes as described in FIGS. 2I and 2J were performed to manufacture the DTR media.

With respect to the resultant DTR media, a glide test was carried out by using a glide head of a designed flying height of 15 nm to which an acoustic emission (AE) sensor is attached so as to examine contact of the head with the media. As a result, no AE signal was observed. When the surface of the media was observed with an AFM, the surface roughness Ra was 0.6 nm and the depths of the recesses were 8 nm. When the glide head was observed with an optical microscope after the measurement, no adhesion of the lubricant to the head slider was observed.

### Comparative Example 2

A DTR media was manufactured by a method in which a deposition process for a nonmagnetic material (SiO₂) is carried out only once using the same stamper as in Example 1. That is, in the deposition process for the first nonmagnetic material 55 (FIG. 2F), 100 nm-thick SiO₂ was deposited under an Ar pressure of as high as 7.0 Pa, and SiO₂ was etched back to manufacture the DTR media.

With respect to the resultant DTR media, a glide test was carried out by using a glide head of a designed flying height of 15 nm to which an acoustic emission (AE) sensor is attached so as to examine contact of the head with the media. As a result, an AE signal was observed which was conceivable that the head had contacted abnormal bumps. A flying test was carried out over a radial position where no AE signal was observed. When the glide head was observed with an optical microscope after the measurement, adhesion of the lubricant to the head slider was observed. When the surface of the media was observed with an AFM, the surface roughness Ra was 2.0 nm and the depths of the recesses were 10 nm. It was found that since dust causing abnormal bumps was easily produced an RF sputtering of SiO₂ as well as flying characteristics of the head were made unstable because of the great surface roughness Ra of the media, adhesion of the lubricant to the head was brought about.

Note that, when SiO₂ is deposited in one deposition process and then is etched back, the surface roughness Ra cannot be low. However, it is possible to make the surface roughness Ra low by depositing SiO₂ as the nonmagnetic material in two stages in accordance with the method of the embodiment.

### Example 4

A DTR media was manufactured as follows using the same stamper as in Example 1 and using Cu as a second nonmagnetic material.

In the deposition process for the first nonmagnetic material 55 (FIG. 2F), 50 nm-thick carbon was deposited under an Ar pressure of as high as 7.0 Pa. In the surface reforming process (FIG. 2G), the first nonmagnetic material 55 was irradiated with Ar ions for one minute using an ECR ion gun under a microwave power of 800 W, and an accelerating voltage of 500V. In the deposition process for the second nonmagnetic material 56 (FIG. 2H), the substrate was heated at 300° C. for 10 seconds in order to obtain a reflow effect and then 10 nm-thick Cu was deposited under an Ar pressure of as low as 0.52 Pa. Other processes as described in FIGS. 2I and 2J were performed to manufacture the DTR media.

With respect to the resultant DTR media, a glide test was carried out by using a glide head of a designed flying height of 15 nm to which an acoustic emission (AE) sensor is attached so as to examine contact of the head with the media. As a result, no AE signal was observed. When the surface of the media was observed with an AFM, the surface roughness Ra was 0.4 nm and the depths of the recesses were 2 nm or less. When the glide head was observed with an optical microscope after the measurement, no adhesion of the lubricant to the head slider was observed.

### Comparative Example 3

A DTR media was manufactured by a method in which a deposition process for a nonmagnetic material (Cu) is carried out only once using the same stamper as in Example 1. That is, in the deposition process for the first nonmagnetic material 55 (FIG. 2F), the substrate was heated at 300° C. for 10 seconds in order to obtain a reflow effect and then 100 nm-thick Cu was deposited under an Ar pressure of as high as 7.0 Pa, and Cu was etched back to manufacture the DTR media.

When the surface of the media was observed with an AFM, the surface was extremely flat such that the surface roughness Ra was 0.4 nm and the depths of the recesses were 2 nm or less. However, the signal-to-noise ratio of the read signals from the media was extremely degraded. When the magnetic properties of the media was measured with a Kerr effect detector, the coercivity was lowered to 2 kOe from the usually value of about 4 kOe. This may be because the nonmagnetic metal Cu was resolved in a CoCrPt alloy of the ferromagnetic recording layer to be alloyed.

The aforementioned embodiments demonstrate the following. The DTR media manufactured by the method according to the embodiments including multi-stage deposition processes of a nonmagnetic material and a surface reforming process exhibit low surface roughness Ra and favorable flying stability of the head. Further, because there is no problem of magnetic coupling with a ferromagnetic recording layer even if a metal nonmagnetic material is used as a second nonmagnetic material, it is possible to further reduce the surface roughness Ra and the depths of the recesses, which contributes to the flying stability of the head.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of manufacturing a patterned media comprising a substrate and a magnetic recording layer on the substrate including protruded magnetic patterns and a nonmagnetic material filling recesses between the magnetic patterns, the method comprising:
depositing a first nonmagnetic material to fill the recesses between the magnetic patterns;
carrying out surface reforming of the first nonmagnetic material;
depositing a second nonmagnetic material on the first nonmagnetic material; and
etching back the second and first nonmagnetic materials.

2. The method according to claim 1, wherein the deposition of the first nonmagnetic material is carried out by sputtering under a pressure of 1 to 10 Pa without applying a substrate bias.

3. The method according to claim 1, wherein the surface reforming is carried out by ion beam etching under a pressure of 1 to 10 Pa.

4. The method according to claim 1, wherein the deposition of the second nonmagnetic material is carried out by sputtering under a pressure less than 1 Pa without applying a substrate bias.

5. The method according to claim 4, wherein the deposition of the second nonmagnetic material is carried out by sputtering under a pressure between 0.35 to 0.6 Pa without applying the substrate bias.

6. The method according to claim 1, wherein the surface reforming and the deposition of the second nonmagnetic material are repeated a plurality of times.

7. The method according to claim 1, wherein the first and second nonmagnetic materials are formed of carbon.

8. The method according to claim 7, wherein the first nonmagnetic material formed of carbon has a thickness of 30 to 100 nm.

9. The method according to claim 7, wherein the second nonmagnetic material is subjected to the surface reforming with Ar or a mixed gas of Ar and O₂.

10. The method according to claim 7, wherein the second nonmagnetic material formed of carbon has a thickness of 50 nm or less.

11. The method according to claim 1, wherein the first and second nonmagnetic materials are formed of different materials.

12. The method according to claim 11, wherein the first nonmagnetic material is selected from the group of Si-based nonmagnetic materials consisting of SiO₂, SiC and SiN, and the second nonmagnetic material is formed of carbon.

13. The method according to claim 12, wherein the second nonmagnetic material is subjected to the surface reforming with a mixed gas of Ar and CF₄.

14. The method according to claim 12, wherein the first nonmagnetic material is carbon or Si-based nonmagnetic material, and the second nonmagnetic material is selected from the group of metals consisting of Ti, Ta, W, Pt, Pd, Ru, Rh, Cu, Al, Ag, and Au.
